(19) United States
(12) Patent Application Publication
(10) Pub. No.: US 2004/0230830 A1
(43) Pub. Date: Nov. 18, 2004

(54) Receiver, connection controller, transmitter, method, and program

(75) Inventors: Katsuhisa Ogawa, Tokyo (JP); Masahiko Kosaka, Kanagawa (JP); Naohiko Suzuki, Tokyo (JP); Hiroaki Nakazawa, Kanagawa (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/842,747

(22) Filed: May 10, 2004

(30) Foreign Application Priority Data
May 16, 2003 (JP) 2003-139029

(51) Int. Cl. H04L 9/00

(52) U.S. Cl. 713/200

(57) ABSTRACT

A receiver receives first and second signals (first and second receiver signals) and permits connection with a connection request source (transmitter) on the basis of a port number included in the second signal (second receiver signal) when the first signal (first receiver signal) satisfies a predetermined condition. The port for accepting the connection request may be variable. The second signal (second receiver signal) may include data designating a program. A connection controller may receive a first signal (first controller signal) from the receiver and send a second signal (second controller signal) to a transmitter, the second signal (second controller signal) designating the port of the receiver for accepting the connection request from the transmitter. The transmitter receives the second signal (second controller signal) from the connection controller and sends the second signal (second receiver signal) including the port number designated by the second signal (second controller signal) to the receiver.

### BACKGROUND OF THE INVENTION

1. Field of the Invention

The present invention relates to receivers, connection controllers, transmitters, methods, and programs.

2. Description of the Related Art

Clients have been connected inside a firewall and have been provided with a private address. When clients access the Internet, routers and firewalls have used a network address translation (NAT) function for converting a private address into a global address. Setting of firewalls has not been performed dynamically.

Also, a high load has been needed for preventing denial of service (DoS) attacks.

### SUMMARY OF THE INVENTION

The present invention addresses the above-identified problems including reducing a load to provide security to a communication apparatus and reducing a load to prevent DoS attacks.

According to an aspect of the present invention, a receiver is provided that receives first and second signals and that permits connection with a connection request source on the basis of a port number included in the second signal when the first signal satisfies a predetermined condition.

According to another aspect of the present invention, a receiver, a receiving method, and a receiving program are provided that send a sending signal including port information corresponding to a port for accepting a connection request, the port being variable, and that permits the connection request by a receiving signal designating the port corresponding to the port information.

According to another aspect of the present invention, a receiver, a receiving method, and a receiving program are provided that receive first and second signals, the second signal including data for designating a program, and that permit connection with a connection request source on the basis of the data designating the program when the first signal satisfies a predetermined condition.

According to yet another aspect of the present invention, a receiver is provided that sends a sending signal including first data, that receives a receiving signal including second data for designating a program, and that permits a connection request by the receiving signal when the second data corresponds to the first data.

According to yet another aspect of the present invention, a connection controller and a connection control method are provided that receive a first signal from a first device and that send a second signal to a second device, the second signal designating a port of the first device for accepting a connection request from the second device.

According to still another aspect of the present invention, a transmitter, a sending method, and a sending program are provided that receive a first signal from a connection controller and that send a second signal including a port number designated by the first signal to a connection request destination.

Further features and advantages of the present invention will become apparent from the following description of the preferred embodiments with reference to the attached drawings.

### BRIEF DESCRIPTION OF THE DRAWINGS

FIG. 1 shows an overview of the present invention.

FIG. 2 shows commands transferred among a connection request terminal (terminal A), an authentication server, and a connection terminal (terminal B) to be connected and the flow of a connection procedure according to a first embodiment.

FIG. 3 is a block diagram showing the structure of the connection terminal to be connected.

FIG. 4 shows the module structure of the connection request terminal.

FIG. 5 shows the module structure of the authentication server.

FIG. 6 shows the structure of an ID and password table.

FIG. 7 shows the module structure of the connection terminal to be connected.

FIG. 8 shows the structure of a connection acknowledgement table of the connection terminal to be connected.

FIG. 9 shows the format of an authentication request command sent from the connection request terminal to the authentication server.

FIG. 10 shows the format of a connection acknowledgement instruction command issued from the authentication server to the connection terminal to be connected.

FIG. 11 is a flowchart of the process of operation of the connection request terminal, which sends a connection request.

FIG. 12 is a flowchart of the process of operation of the authentication server.

FIG. 13 is a flowchart showing the process of operation of the connection terminal to be connected.

FIG. 14 shows commands and the flow of a connection procedure according to a modification of the first embodiment.

FIG. 15 shows the module structure of a connection terminal to be connected according to the modification of the first embodiment.

FIG. 16 shows commands and the flow of a connection procedure according to a second embodiment.

FIG. 17 shows the module structure of a connection terminal to be connected according to the second embodiment.

FIG. 18 shows commands and the flow of a connection procedure according to a modification of the second embodiment.

FIG. 19 shows the module structure of a connection terminal to be connected according to the modification of the second embodiment.

### DESCRIPTION OF THE PREFERRED EMBODIMENTS

First Embodiment

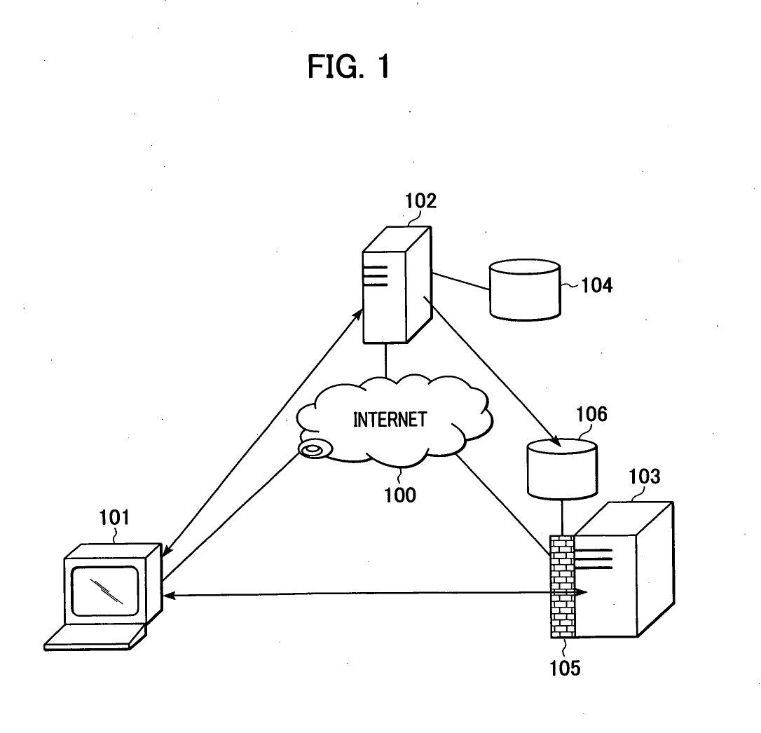

FIG. 1 shows a first embodiment of the present invention.

An Internet network 100 is an example of a network. A connection request terminal (hereinafter, referred to as a terminal A) 101 is connected to the Internet network 100. An authentication server 102 is also connected to the Internet network 100. The authentication server 102 includes an ID and password table 104 that stores at least one pair of ID and password corresponding to the ID. A connection terminal (hereinafter, referred to as a terminal B) 103 to be connected holds a connection port switching unit 105 so that connection from an unspecified point is normally rejected. Also, a connection acknowledgement table 106 stores information for permitting connection by the connection port switching unit 105 when connection is required.

According to the present invention, the terminal B 103 is a receiver and the terminal A 101 is a transmitter. The authentication server 102 is a connection controller for setting the terminal B 103 via the Internet network 100.

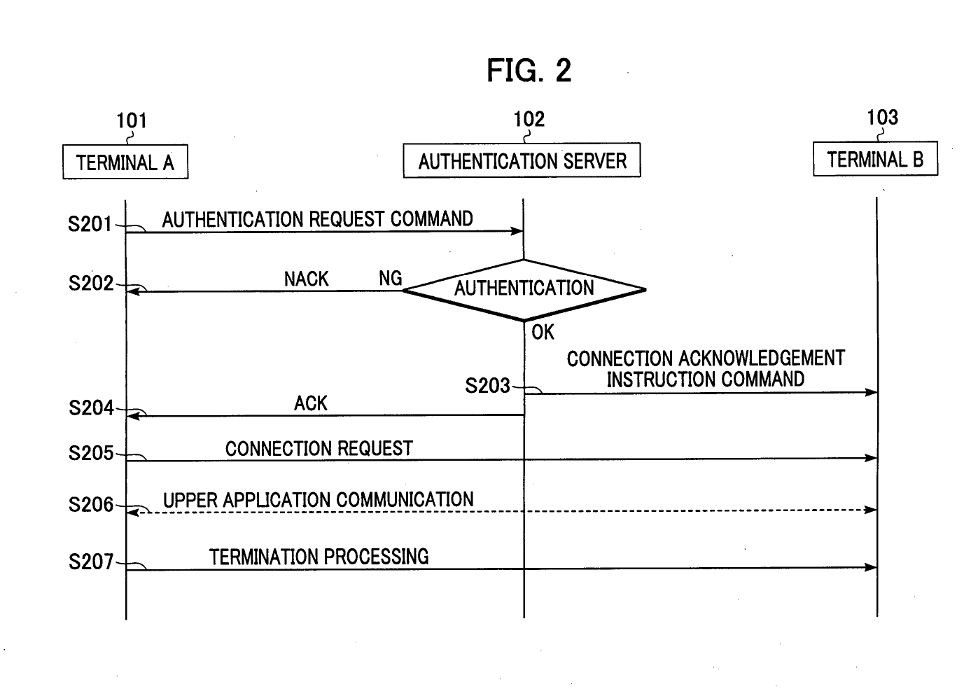

FIG. 2 shows commands transferred among the terminal A 101, the authentication server 102, and the terminal B 103 and the flow of the connection procedure according to the first embodiment.

For starting communication with the terminal B 103, the terminal A 101, which sends a connection request, issues an authentication request command to the authentication server 102 in step S201. The format and parameters of the authentication request command in S201 are described below.

If authentication is not successful for the authentication request command sent in step S201, the authentication server 102 sends a connection negative acknowledgement response (NACK) in step S202. If authentication is successful for the authentication request command sent in step S201, the authentication server 102 issues a connection acknowledgement instruction command to the terminal B 103 in step S203. The authentication server 102 also sends a connection acknowledgement response (ACK) to the terminal A 101 in step S204. Steps S203 and S204 may be performed in reverse order. Also, when a connection acknowledgement response (ACK) to the connection acknowledgement instruction command in step S203 is sent from the terminal B 103, the authentication server 102 may send the connection acknowledgement response (ACK) in step S204.

The terminal A 101 receives the connection acknowledgement response (ACK) in step S204, and issues a connection request command to the terminal B 103 in step S205.

In standby mode, the terminal B 103 is set so as to ignore (or reject) any command other than a predetermined command (e.g., a connection acknowledgement instruction command) sent from the authentication server 102. The terminal B 103 in standby mode accepts only a command having a predetermined source IP address. In an example, a source IP address of a received command is equal to a predetermined IP address, and a port number of the terminal B 103 designated by the received command is equal to a predetermined number. The terminal B 103 receives the connection acknowledgement instruction command (predetermined signal) sent from the authentication server 102 in step S203 in the standby mode, and permits (or rejects) connection (connection between the terminal A 101 and an upper application) under the conditions according to the connection acknowledgement instruction command. The connection acknowledgement instruction command sent in step S203 includes port number information indicating a port number of the terminal B 103 for accepting the connection request from the terminal A 101.

After receiving the port number information, the terminal B 103 ignores (or rejects) any connection request that does not designate the corresponding port number. In other words, the terminal B 103 changes the conditions for permitting connection in accordance with the port number information included in the connection acknowledgement instruction command sent in step S203. In other words, connection from any device other than the authentication server 102 is rejected before receiving the connection acknowledgement instruction command (predetermined signal) sent in step S203, and connection from the terminal A 101 is permitted by the port designated by the port number information included in the connection acknowledgement instruction command sent in S203 after receiving the connection acknowledgement instruction command sent in step S203. The terminal B 103 receives the connection request in step S205, and then, the upper application communication starts in step S206. The upper application is identified by the port number that accepts the connection request from the terminal A 101 and the protocol class. When the upper application communication in step S206 ends, a termination processing command is sent in step S207. The terminal B 103 returns to standby mode in which any command other than a predetermined command sent from the authentication server 102 is ignored (or rejected).

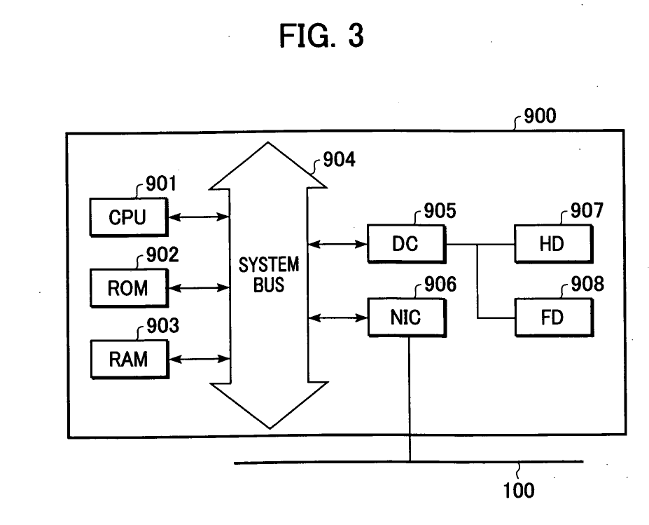

With the structure of a computer 900, for example, shown in FIG. 3, the terminal B 103 (including the connection port switching unit 105 and the connection acknowledgement table 106) realizes functions of the first embodiment. A central processing unit (CPU) 901, a read-only memory (ROM) 902, a random access memory (RAM) 903, a disk controller (DC) 905 for a hard disc (HD) 907 and a floppy disk (FD) 908, and a network interface card (NIC) 906 are connected so as to communicate with each other via a system bus 904 in the computer 900. The NIC 906 connects the Internet network 100 shown in FIG. 1 to the system bus 904.

The CPU 901 generally controls each component part connected to the system bus 904 by executing software stored in the ROM 902 or the HD 907 or software supplied from the FD 908. In other words, the CPU 901 performs control to realize the operations of the first embodiment by reading and executing a processing program based on the processing sequence described below from the ROM 902, the HD 907, or the FD 908.

The RAM 903 functions as a main memory, a work area, or the like of the CPU 901. The DC 905 controls access to the FD 908 and the HD 907 storing a boot program, various applications, an edit file, a user file, a network management program, the processing program described below according to the first embodiment, and the like. The NIC 906 transfers data to and from the terminal A 101, the authentication server 102, and the like via the Internet network 100.

Under the control of the CPU 901, the NIC 906 functions as the connection port switching unit 105 for normally rejecting connection from an unspecified point. Also, the RAM 903 or the HD 907 holds the connection acknowledgement table 106. When a connection request is given, the CPU 901 determines whether or not to permit the connection by referring to the connection acknowledgement table 106.

The terminal A 101 and the authentication server 102 can also be arranged in a similar manner to the computer 900, as shown in FIG. 3, as in the terminal B 103.

The RAM 903 or the HD 907 of the authentication server 102 holds the ID and password table 104 shown in FIG. 1.

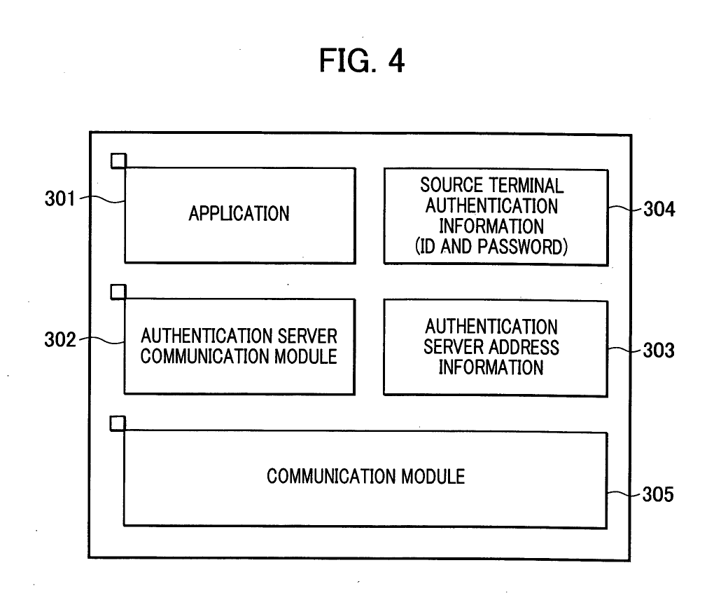

FIG. 4 shows the module structure of software of the terminal A 101. The modules shown in FIG. 4 are supplied from the ROM 902, the HD 907, or the FD 908 of the terminal A 101.

An application 301 transfers data to and from the terminal B 103. For starting communication between the application 301 and the terminal B 103, an authentication server communication module 302 requests the authentication server 102 shown in FIG. 1 to perform authentication. Here, authentication server address information 303 stored in advance as information of the authentication server 102 is used. Also, source terminal authentication information 304 stored in advance in order to authenticate the terminal A 101 in the authentication server 102 is used. In other words, the authentication request command sent in step S201 includes the authentication server address information 303 and the source terminal authentication information 304. The source terminal authentication information 304 includes an ID of the terminal A 101 and a password input by using a keyboard (not shown) of the terminal A 101. All the communication is performed by a common communication module 305.

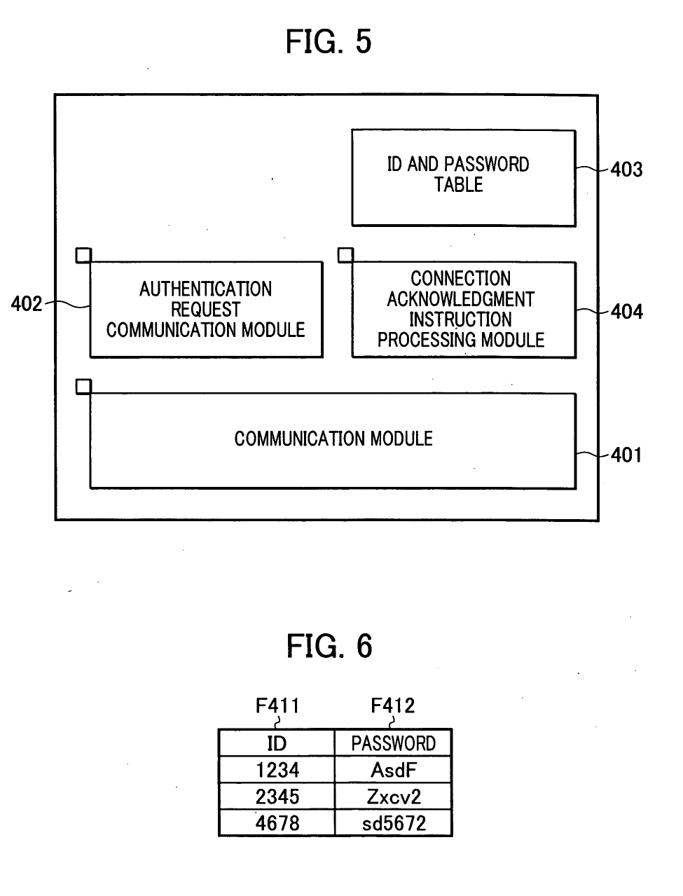

FIG. 5 shows the module structure of software of the authentication server 102. The modules shown in FIG. 5 are supplied from the ROM 902, the HD 907, or the FD 908 of the authentication server 102.

The authentication request command sent from the terminal A 101 in step S201 is processed in an authentication request communication module 402 via a communication module 401. For this authentication processing, an ID and a password stored in an ID and password table 403 and the source terminal authentication information 304 of the terminal A 101 included in the authentication request command sent in step S201 are used. The ID and password table 403 is equal to the ID and password table 104 shown in FIG. 1. If the authentication is successful, a connection acknowledgement instruction processing module 404 sends the connection acknowledgement instruction command in step S203 to the terminal B 103. The connection acknowledgement instruction processing module 404 also sends a connection acknowledgement response (ACK) in step S204 (or a connection negative acknowledgement response (NACK) in step S202) to the terminal A 101.

FIG. 6 shows the structure of the ID and password table 403 (or 104).

An ID for identifying a connection request terminal is stored in an ID field F411. A password stored in a password field F412 corresponds to the ID stored in the ID field F411. The ID and password table 403 (or 104) is registered in the RAM 903 or the HD 907 by using a keyboard (not shown).

The authentication server 102 receives port number information from the terminal A 101, and reports the port number information received from the terminal A 101 to the terminal B 103, which is a receiver.

Also, the authentication server 102 may determine a port number and may report port number information indicating the determined port number to the terminal A 101 and the terminal B 103, and the terminal A 101 and the terminal B 103 may require connection and may determine whether or not to permit the connection, respectively, in accordance with the port number information determined and reported by the authentication server 102. In this case, the report about the port number information sent from the authentication server 102 to the terminal A 101 is included, for example, in the connection acknowledgement response (ACK) sent in step S202.

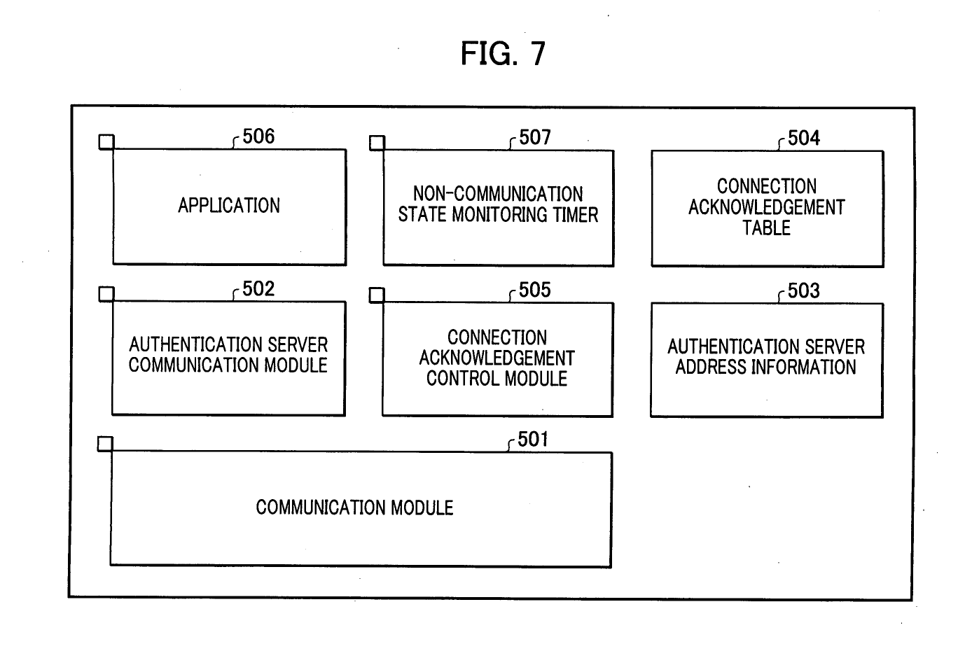

FIG. 7 shows the module structure of software of the terminal B 103. The modules shown in FIG. 7 are supplied from the ROM 902, the HD 907, or the FD 908 of the terminal B 103.

For connection, a connection acknowledgement instruction command (predetermined signal) is sent from the authentication server (first communicating device) 102 in step S203. If the connection acknowledgement instruction command sent in step S203 includes a predetermined port number, the connection acknowledgement instruction command is processed in an authentication server communication module 502 via a communication module 501. The connection acknowledgement instruction command sent in step S203 includes address information of the authentication server 102. The authentication server communication module 502 verifies that the connection acknowledgement instruction command is not a forgery by referring to authentication server address information 503.

If the connection acknowledgement instruction command is sent from the authentication server (first communicating device) 102 included in the authentication server address information 503, the authentication server communication module 502 analyzes the format of the connection acknowledgement instruction command sent in step S203 to set a value in a connection acknowledgement table 504. The value set in the connection acknowledgement table 504 is a value for permitting the connection request in step S205 sent from the terminal A 101. The connection acknowledgement instruction command sent in step S203 includes this value and the terminal A 101 adds this value in the connection request sent in step S205. Then, when the connection request in step S205 is directly sent from the terminal A (second communicating device) 101, a connection acknowledgement control module 505 refers to the connection acknowledgement table 504 to determine whether to send the connection request to an upper application 506 (in other words, to permit connection with the upper application 506) or to reject the communication (in other words, to reject the connection with the upper application 506) depending on whether or not the value included in the connection request sent in step S205 is set in the connection acknowledgement table 504. For example, a value set in the connection acknowledgement table 504 is a port number used for designating an application of the terminal B 103. This value may be determined by the authentication server 102 and reported to the terminal A 101 and the terminal B 103, and the terminal A 101 may add the value in the connection request command sent in step S205.

The connection acknowledgement condition is set in the connection acknowledgement table 504. The authentication server communication module 502 rewrites (changes) the connection acknowledgement condition set in the connection acknowledgement table 504 in accordance with the port number information and the like included in the connection acknowledgement instruction command sent in step S203.

Since an entry is left in the connection acknowledgement table 504 for a long time if normal termination cannot be achieved, a non-communication state monitoring timer 507 for monitoring a non-communication state and deleting the entry in the connection acknowledgement table 504 after a predetermined time is provided.

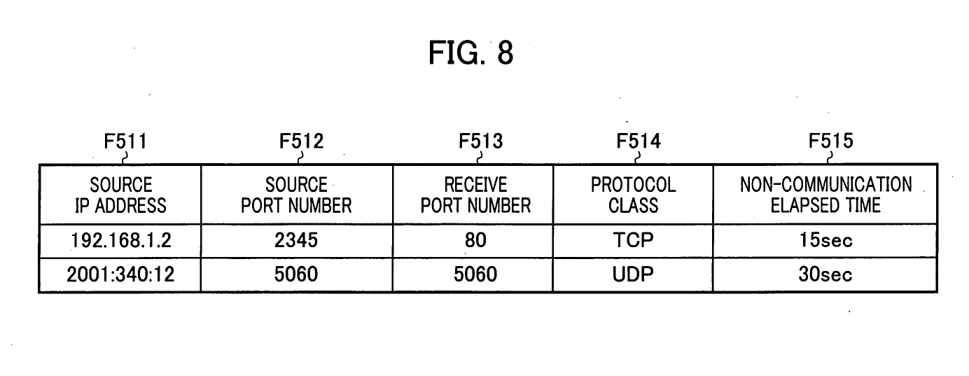

FIG. 8 shows the structure of the connection acknowledgement table 504 of the terminal B 103.

Each entry is created by the connection acknowledgement instruction command in step S203 sent from the authentication server 102 and is deleted by the termination processing in step S207 initiated by the terminal A 101 or by the non-communication state monitoring timer 507.

A source IP address stored in a source IP address field F511 corresponds to an IP address of the terminal A 101. A source port number is stored in a source port number field F512. A receive port number stored in a receive port number field F513 and the protocol class stored in a protocol class field F514 function as an identifier indicating the upper application 506. Non-communication elapsed time stored in a non-communication elapsed time field F515 is set by the non-communication state monitoring timer 507. When the value in the non-communication elapsed time field F515 exceeds a predetermined value, a corresponding entry is deleted.

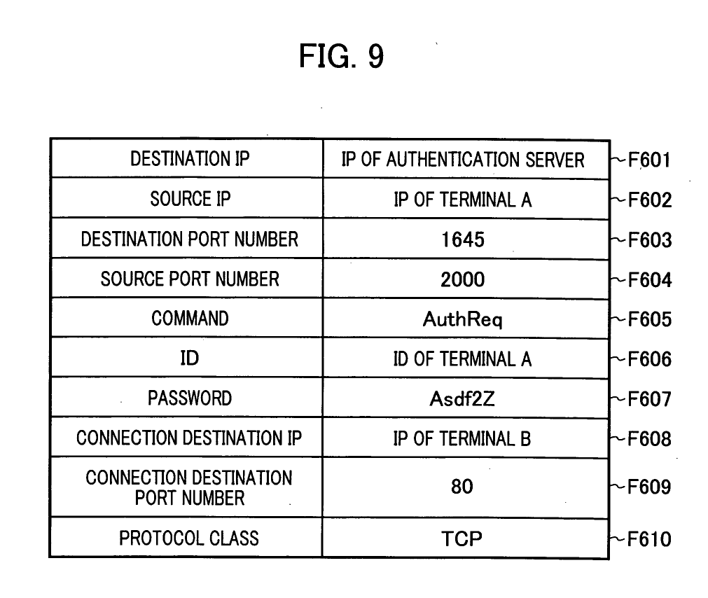

FIG. 9 shows the format of the authentication request command in step S201 sent from the terminal A 101 to the authentication server 102. An IP packet composed of header and payload is logically represented.

Fields F601 to F604 store information included in the header of the IP packet.

An IP address of the authentication server 102 is stored in a destination IP field F601 and is used as a destination for transferring the packet to the authentication server 102. The terminal A 101 uses the authentication server address information 303 (see FIG. 4) as a destination IP address stored in the destination IP field F601. An IP address of the terminal A 101 is stored in a source IP field F602. A port number stored in a destination port number field F603 corresponds to the authentication request communication module 402 of the authentication server 102. In the first embodiment, the port number 1645 is used. For both the terminal A 101 and the terminal B 103 used for the authentication server 102, this number is unique and known. The authentication request command in step S201 including the value “1645” in the destination port number field F603 is processed by the authentication request communication module 402 via the communication module 401.

A port number stored in a source port number field F604 is a port number when the terminal A 101 issues the authentication request command. Although the port number can be changed depending on the command, the same port number is used for the authentication request command sent in step S201 and the connection request sent in step S205 in the first embodiment.

Fields F605 to F610 correspond to the payload of the IP packet. Here, description is given such that a part corresponding to TCP and UDP protocols is omitted.

A character string [AuthReq] indicating the authentication request command is stored in a command field F605. An ID peculiar to the terminal A 101 is stored in an ID field F606. Also, a password stored in a password field F607 is a character string for a password corresponding to the ID. The terminal A 101 uses the ID and the password included in the source terminal authentication information 304 (see FIG. 4) as the ID stored in the ID field F606 and the password stored in the password field F607. An IP address of the terminal B 103 to which the terminal A 101 desires to be connected is stored in a connection destination IP field F608. Also, a port number corresponding to the application 506 of the terminal B 103 to which the terminal A 101 desires to be connected is stored in a connection destination port number field F609 and the protocol class is stored in a protocol class field F610.

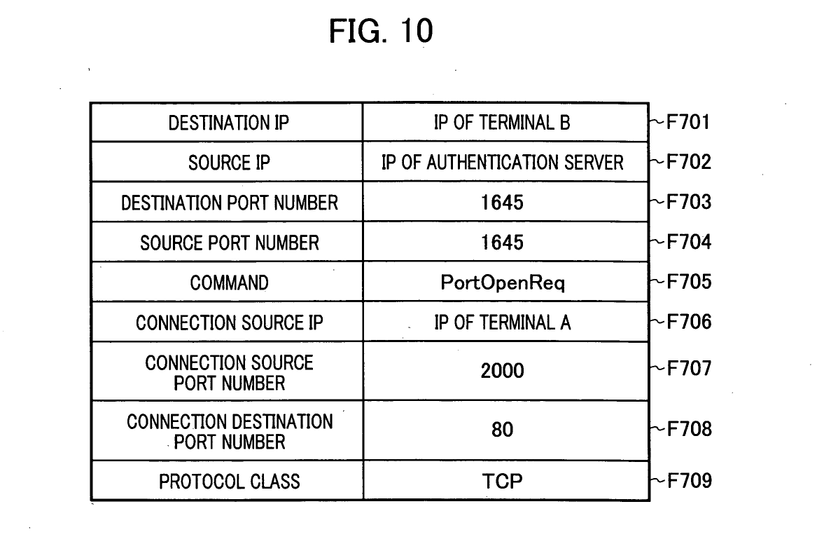

FIG. 10 shows the format of the connection acknowledgement instruction command in step S203 issued from the authentication server 102 to the terminal B 103. An IP packet composed of header and payload is logically represented.

Fields F701 to F704 store information included in the header of the IP packet.

An IP address of the terminal B 103 is stored in a destination IP field F701 and is used as a destination for transferring the packet to the terminal B 103. The authentication server 102 uses the IP address of the terminal B 103 stored in the connection destination IP field F608 of the authentication request command in step S201 as the destination IP address. An IP address of the authentication server 102 is stored in a source IP field F702. A port number stored in a destination port number field F703 corresponds to the authentication server communication module 502 of the terminal B 103. In the first embodiment, the port number 1645 is used. For all the terminals for receiving the connection acknowledgement instruction command in step S203 sent from the authentication server 102, this number is unique and known. The connection acknowledgement instruction command in step S203 including the value “1645” in the destination port number field F703 is processed by the authentication server communication module 502 via the communication module 501.

A port number stored in a source port number field F704 is a port number when the authentication server 102 issues the connection acknowledgement instruction command. In the first embodiment, this port number is equal to the port number stored in the destination port number field F603 (a port number corresponding to the authentication request communication module 402 of the authentication server 102) of the authentication request command sent in step S201.

Fields F705 to F709 correspond to the payload of the IP packet. Here, description is given such that a part corresponding to TCP and UDP protocols is omitted.

A character string [PortOpenReq] indicating the connection acknowledgement instruction command is stored in a command field F705. An IP address of the terminal A 101 is stored in a connection source IP field F706. The authentication server 102 uses the IP address of the terminal A 101 stored in the source IP field 602 of the authentication request command sent in step S201 as the IP address of the terminal A 101 stored in the connection source IP field 706.

A port number stored in a connection source port number field F707 is a port number to be used when the terminal A 101 is connected to the terminal B 103. The authentication server 102 uses the port number that is used when the terminal A 101 issues the authentication request command and that is stored in the source port number field F604 of the authentication request command sent in step S201 as the connection source port number stored in the connection source port number field F707. Any port number other than the port number that is used when the terminal A 101 issues the authentication request command and that is stored in the source port number field F604 may be used as the port number stored in the connection source port number field F707 to be used when the terminal A 101 is connected to the terminal B 103. In this case, the port number to be used when the terminal A 101 is connected to the terminal B 103 is added in the authentication request command sent in step S201.

A port number stored in a connection destination port number field F708 corresponds to the application 506 of the terminal B 103 to which the terminal A 101 desires to be connected. The authentication server 102 uses the port number that corresponds to the application 506 of the terminal B 103 and that is stored in the connection destination port number field F609 of the authentication request command sent in step S201 as the port number that corresponds to the application 506 of the terminal B 103 to which the terminal A 101 desires to be connected and that is stored in the connection destination port number field F708. A protocol class is stored in a protocol class field F709. The authentication server 102 uses the protocol class stored in the protocol class field F610 included in the authentication request command sent in step S201 as the protocol class stored in the protocol class field F709.

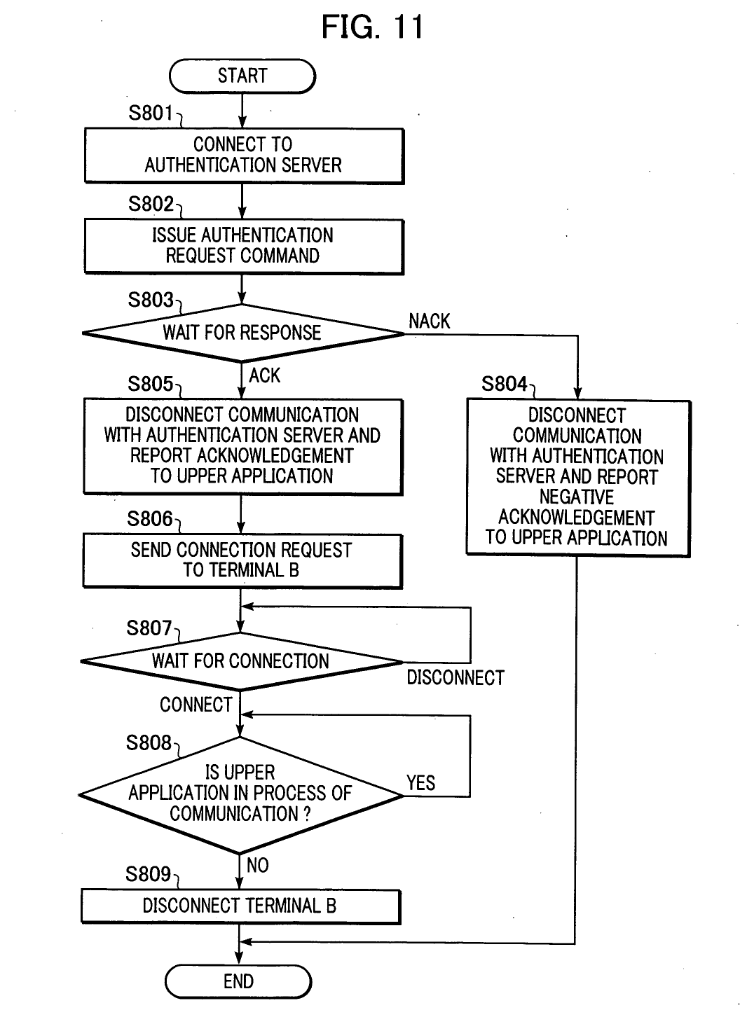

FIG. 11 is a flowchart showing the process of operation of the terminal A 101, which sends a connection request, according to the first embodiment. This flowchart shows a program read from the ROM 902, the HD 907, or the FD 908 and executed by the CPU 901.

When a request for communication is given by the application 301, the terminal A 101 is connected to the authentication server 102 in step S801. A connection destination IP address used here is an IP address stored in the authentication server address information 303. In step S802, the authentication request command in step S201 (see FIG. 9) is issued from the authentication server communication module 302. The authentication request command in step S201 includes the connection destination port number in the connection destination port number field F609. The connection destination port number in the connection destination port number field F609 and the protocol class in the protocol class field F610 identify the application 506 of the terminal B 103.

In step S803, the terminal A 101 waits for the connection acknowledgement response in step S204 or the connection negative acknowledgement response in S202. If the connection negative acknowledgement response (NACK) in step S202 is received, the process proceeds to step S804. If the connection acknowledgement response (ACK) in step S204 is received, the process proceeds to step S805.

In step S804, since processing cannot be carried any further, the communication with the authentication server 102 is disconnected, and the authentication server communication module 302 reports the connection negative acknowledgement to the application 301, which sent the authentication request, to terminate the processing.

In step S805, the communication with the authentication server 102 is disconnected, and the authentication server communication module 302 reports the connection acknowledgement to the application 301. In accordance with the connection acknowledgement, the terminal A 101 is connected to the terminal B 103.

In step S806, the application 301 issues the connection request in step S205 for starting communication with the terminal B 103 with the upper application. The connection request in step S205 includes a connection destination port number and a protocol class. The connection destination port number and the protocol class identify the application 506 of the terminal B 103. In step S807, the terminal A 101 waits for the actual connection in accordance with the connection request in step S205. This processing is performed, for example, for TCP session establishment and for the upper application.

In step S808, it is determined whether or not the application 301 is in the process of communication. If the application 301 terminates the communication, the communication module 305 disconnects the communication (step S207) with the terminal B 103 in step S809.

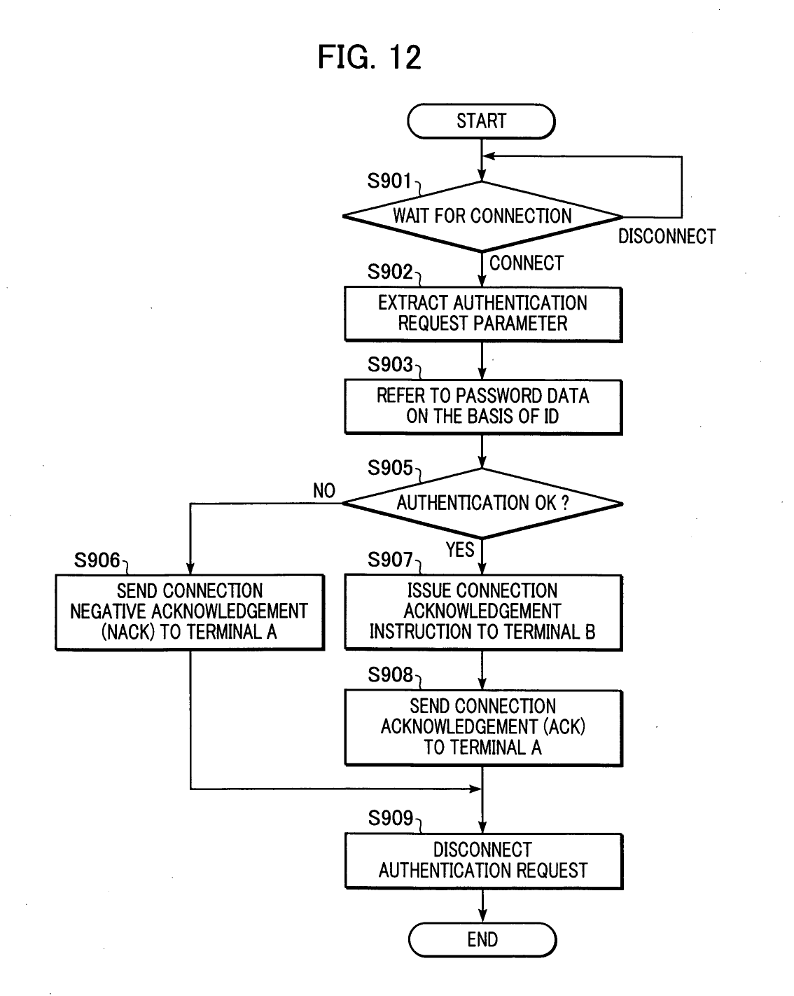

FIG. 12 is a flowchart showing the process of operation of the authentication server 102 according to the first embodiment. This flowchart shows a program read from the ROM 902, the HD 907, or the FD 908 and executed by the CPU 901.

The authentication server 102 always waits for an authentication request from a terminal.

In step S901, the authentication server 102 waits for the authentication request sent from the terminal A 101. When the authentication request is sent from the terminal A 101, the parameters stored in the fields F601 to F610 of the authentication request command in step S201 are extracted in step S902.

In step S903, the character string for a password is extracted from the ID and password table 403 on the basis of the ID stored in the ID field F606 to be compared with the character string stored in the password field F607. If it is determined that the character strings are equal to each other in step S905, the authentication is successful, and the process proceeds to step S907. If it is determined that the character strings are not equal to each other in step S905, the authentication is not successful, and the process proceeds to step S906.

In step S906, since the processing cannot be carried any further, the connection negative acknowledgement in step S202 is sent to the terminal A 101, and the communication with the terminal A 101 is disconnected (step S909) to terminate the processing.

In step S907, the connection acknowledgement instruction command in step S203 is issued to the terminal B 103. The connection acknowledgement instruction command in step S203 includes the connection destination port number stored in the connection destination port number field F708. The connection destination port number in the connection destination port number field F708 and the protocol class in the protocol class field F709 identify the application 506 of the terminal B 103. The authentication server 102 adds the connection destination port number stored in the connection destination port number field F609 and the protocol class stored in the protocol class field F610 included in the authentication request command in step S201 to the connection acknowledgement instruction command in step S203 as the connection destination port number stored in the connection destination port number field F708 and the protocol class stored in the protocol class field F709, respectively. A command sent from the terminal B 103 to the authentication server 102 to report the connection destination port number in the connection destination port number field F609 and the protocol class in the protocol class field F610 may be provided apart from the authentication request command in step S201. In step S908, the connection acknowledgement response in step S204 is sent to the terminal A 101. In step S909, disconnection processing is performed for the authentication request sent from the terminal A 101.

In other words, the authentication server 102 according to the first embodiment is a setting device that sets the terminal B 103, which is a receiver, via the Internet network 100 under the control of the CPU 901 that executes the processing based on the program shown in FIG. 12. Specifically, port number information (included in the connection acknowledgement instruction command in step S203) for connecting the terminal A 101 is reported to the terminal B 103 (see step S907).

In the first embodiment, the authentication server 102 receives the port number information (included in the authentication request command in step S201) from the terminal A 101 (see step S901), and reports the port number information received from the terminal A 101 to the terminal B 103 (see step S907).

The authentication server 102 may determine a port number and may report port number information indicating the determined port number to the terminal A 101 and the terminal B 103 (see step S907), and the terminal A 101 and the terminal B 103 may send a connection request and may determine whether or not to permit the connection, respectively, in accordance with the port number information determined and reported by the authentication server 102. In this case, the port number information is included, for example, in the connection acknowledgement response (ACK) in step S204, so that the authentication server 102 reports the port number information to the terminal A 101 in step S908.

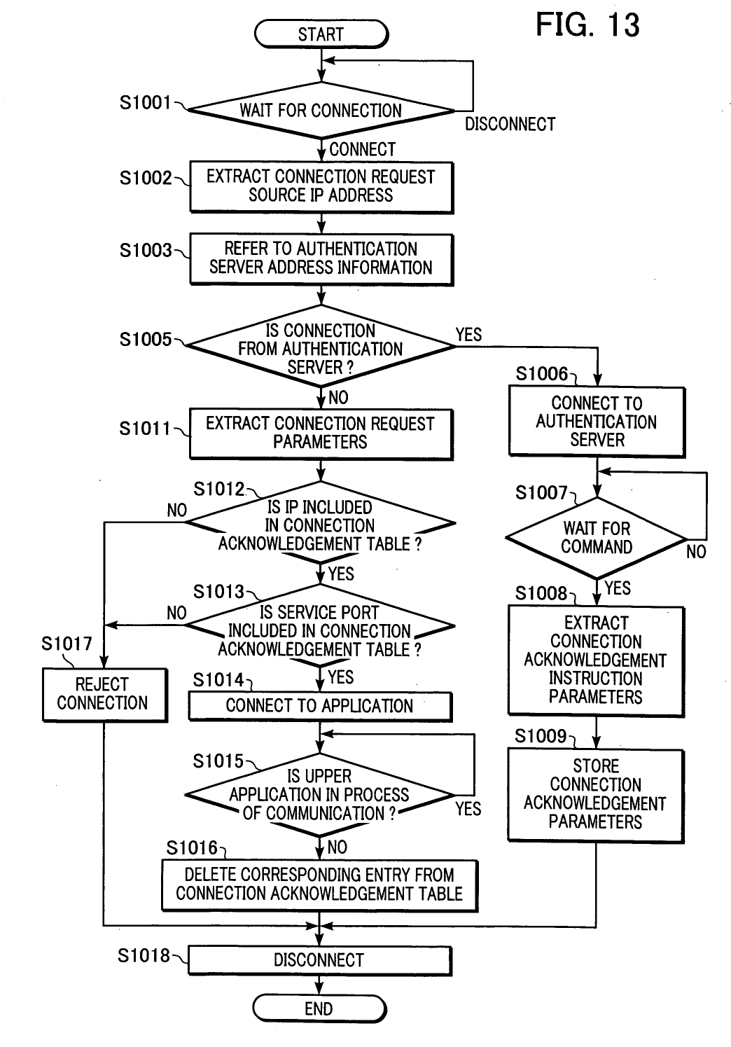

FIG. 13 is a flowchart showing the process of operation of the terminal B 103 according to the first embodiment. This flowchart shows a program read from the ROM 902, the HD 907, or the FD 908 and executed by the CPU 901.

In step S1001, the terminal B 103 waits for connection only from the authentication server 102. The terminal B 103 holds a global IP and is capable of receiving various services. Normally, however, a connection port for accepting communication is only a connection port (port 1645 set in the destination port number field F703 in FIG. 10) for the authentication server communication module 502 to accept communication from the authentication server 102. However, a plurality of authentication servers may be provided.

When a connection request is received in step S1001, an IP address (source IP address) of a connection request source is extracted in step S1002. In step S1003, the IP address of the connection request source is compared with the address of the authentication server 102 by referring to the authentication server address information 503 storing the address of the authentication server 102. If it is determined that the IP address of the connection request source is included in the authentication server address information 503 in step S1005, the process proceeds to step S1006 to accept an instruction from the authentication server 102.

If it is determined that the IP address of the connection request source is not included in the authentication server address information 503 in step S1005, the connection request is regarded as a connection request sent from a general terminal, and the process proceeds to step S1011.

In step S1006, the authentication server communication module 502 is connected to the authentication server 102. In step S1007, the terminal B 103 waits for the connection acknowledgement instruction command in step S203 sent from the authentication server 102. When the connection acknowledgement instruction command in step S203 including a destination port number of 1645 is received, the authentication server communication module 502 extracts the connection acknowledgement instruction parameters stored in the fields F701 to F709 in step S1008. In step S1009, on the basis of the parameters extracted in step S1008, the connection source IP address in the connection source IP field F706, the connection source port number in the connection source port number field F707, the connection destination port number in the connection destination port number field F708, and the protocol class in the protocol class field F709 are stored in the corresponding fields F511 to F514 (shown in FIG. 8) of the connection acknowledgement table 504. The process then proceeds to step S1018 to perform disconnection processing. The non-communication state monitoring timer 507 starts counting time.

In contrast, if it is determined that the connection is not from the authentication server 102 in step S1005, parameters are extracted from a packet of the connection request in step S1011. The parameters extracted here are the IP address of the connection request source, the protocol class, the port number of the connection request source, and a port number of the terminal B 103 desired to be connected.

Then, in step S1012, it is determined whether or not the IP address of the connection request source extracted from the packet is a permitted IP address by referring to the source IP address field F511 of the connection acknowledgement table 504. If the IP address of the connection request source included in the connection request in step S205 is included in the source IP address field F511, the process proceeds to step S1013. If the IP address of the connection request source is not included in the source IP address field F511, the process proceeds to step S1017 to reject the connection.

In step S1013, it is determined whether or not the entries of the IP addresses found in the connection acknowledgement table 504 in step S1012 include the port number desired to be connected that is included in the connection request packet. In the example shown in FIG. 8, if the source IP address is 192.168.1.2, it is determined whether or not the port number desired to be connected that is included in the connection request packet is 80. In other words, after receiving the connection acknowledgement instruction command (first signal) in step S203 including the port number information sent from the authentication server (first communicating device) 102 in step S1007, the terminal B (receiver) 103 permits connection by a second signal (connection request in step S205) received from the terminal A (second communicating device) 101 in accordance with port number information included in the first and second signals (in accordance with comparison between the port designated by the port number information included in the first signal and the port designated by the port number information included in the second signal) in step S1013.

Connection may be restricted by the TCP/UDP protocol class stored in the protocol class field F514 and by the source port number stored in the source port number field F512. In the first embodiment, permission for connection is determined on the basis of the source IP address stored in the source IP address field F511 and the receive port number stored in the receive port number field F513. Alternatively, connection may be restricted only by the receive port number stored in the receive port number field F513.

If the connection is not permitted in step S1013, the process proceeds to step S1017 to reject the connection. However, if the connection is permitted in step S1013, the terminal A 101 is connected to the application 506 in step S1014. The application 506 is identified by the port number of the terminal B 103 desired to be connected and the protocol class extracted from the connection request packet.

In step S1015, it is determined whether or not the application 506 is in the process of communication. If the application 506 terminates the communication, the corresponding entries in the fields F511 to F515 are deleted from the connection acknowledgement table 504 in step S1016. Also, if the non-communication elapsed time counted by the non-communication state monitoring timer 507 and stored in the non-communication elapsed time field F515 is a predetermined time (for example, one minute), the corresponding entries in the fields F511 to F515 are deleted. In any case, the entries in the fields F511 to F515 become ineffective, and connection is not permitted by the information included in the corresponding entries.

In step S1017, connection is rejected before causing the application 506 to start processing. In addition to a simple connection rejection, sending an error response representing the fact that the authentication server 102 is not authenticated may be included in the connection rejection performed here.

In step S1018, each corresponding communication connection is disconnected to terminate the series of communication.

As described above, in the first embodiment, only the terminal A 101 whose IP address is permitted by the connection acknowledgement instruction command in step S203 is connected to the application 506. Although a permitted port number is designated by the authentication server 102 for the terminal B 103 in the first embodiment, a port number other than the permitted port number may be designated. Alternatively, instead of designating the permitted port number itself, for example, a port number of a multiple of 25 may be permitted when 25 is designated.

Accordingly, the security level can be improved depending on the level of the security of the authentication server 102 and the level of authentication performed by the authentication server 102.

Also, only for the purpose of preventing DoS attacks, in a case where the IP address of a terminal who attempts a DoS attack is available, control can be performed only by the IP address even if authentication itself for a client cannot be accurately performed.

Modification of First Embodiment

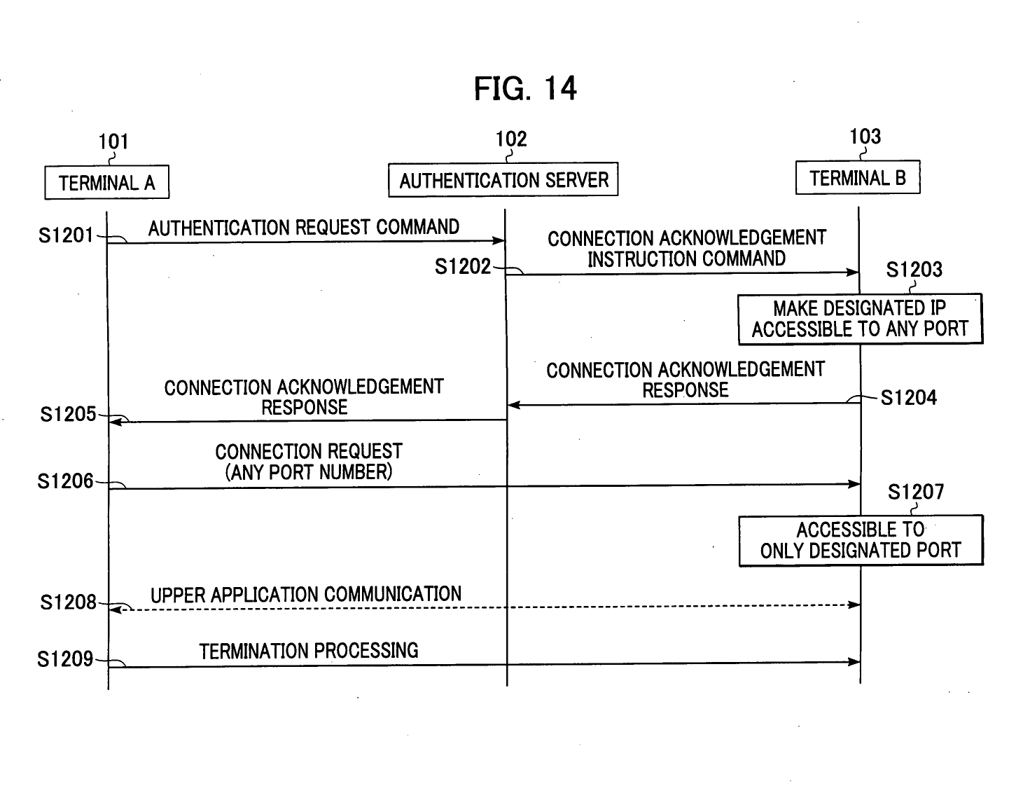

FIG. 14 shows commands and the flow of a connection procedure according to a modification of the first embodiment. The flow shown in FIG. 14 is a modification of the flow shown in FIG. 2.

For starting communication with the terminal B 103, the terminal A 101, which sends a connection request, issues an authentication request command to the authentication server 102 in step S1201.

For the format and parameters of the authentication request command in step S1201, the connection destination port number field F609 and the protocol class field F610 shown in FIG. 9 are not needed.

When connection is permitted for the authentication request command in step S1201, the authentication server 102 issues a connection acknowledgement instruction command to the terminal B 103 in step S1202. The format of the connection acknowledgement instruction command includes fields F701 to F706 shown in FIG. 10.

In standby mode, the terminal B 103 is set so as to ignore (or reject) any command other than a predetermined command (connection acknowledgement instruction command) sent from the authentication server 102. The terminal B 103 in standby mode accepts only a command having a predetermined source IP address. In an example, a source IP address of a received command is equal to a predetermined IP address, and a port number of the terminal B 103 designated by the received command is equal to a predetermined number.

In the standby mode, the terminal B 103 receives the connection acknowledgement instruction command in step S1202 sent from the authentication server 102, and an access from the designated IP address to any port number is permitted in step S1203.

Specifically, the connection acknowledgement table shown in FIG. 8 is set. First, the connection source IP address in the connection source IP field F706 is extracted from the connection acknowledgement instruction command in step S1202 to be set in the source IP address field F511. The other fields F512, F513, and F514 are not particularly limited. (All the source port numbers in the field F512 are permitted. All the receive port numbers in the field F513 are permitted. TCP and UDP protocols in the field F514 are permitted.)

In step S1204, a connection acknowledgement response is sent to the authentication server 102.

In step S1205, the authentication server 102 sends the connection acknowledgement response in step S1204, which is received from the terminal B 103, to the terminal A 101.

After receiving the connection acknowledgement response in step S1205, the terminal A 101 issues a connection request command to the terminal B 103 by using any port number in step S1206. The connection request command in step S1206 includes the IP address of the terminal A 101 and port number information including a port number of the terminal B 103 to which the terminal A 101 desires to be connected.

Since the IP address of the terminal A 101 is already set in the connection acknowledgement table shown in FIG. 8 and the other parameters are not limited (connection to any port is permitted) in step S1203, connection by the connection request command (including the IP address of the terminal A 101) sent from the terminal A 101 in step S1206 can be permitted. In step S1207, the port number connected by step S1206 is extracted and set in the connection acknowledgement table shown in FIG. 8, so that connection to the other ports cannot be permitted. The connected port number is included in the connection request command in step S1206. After receiving the connection request command in step S1206 including the port number, the terminal B 103 ignores (or rejects) any connection request that designates a port number other than the corresponding port number.

In other words, connection acknowledgement conditions are set in the connection acknowledgement table. The connection request in step S1206 includes port number information identifying the port. The connection acknowledgement conditions in the connection acknowledgement table are changed in accordance with the port number information (in other words, connection using a port other than the port identified by the port number information is restricted).

Then, in step S1208, upper application communication starts. The upper application is identified by the port number and the protocol class.

When the upper application communication in step S1208 terminates, a termination processing command is sent in step S1209. The corresponding entries in the fields F511 to F515 are deleted from the connection acknowledgement table 1504. Also, if the non-communication elapsed time counted by a non-communication state monitoring timer 1508 and stored in the non-communication elapsed time field F515 is a predetermined time (for example, one minute), the corresponding entries in the fields F511 to F515 are deleted. The terminal B 103 returns to standby mode in which any command other than a predetermined command sent from the authentication server 102 is ignored (or rejected).

Although connection to any port is permitted in step S1203, for example, connection to a port number that is known by both the terminal A 101 and the terminal B 103 may be permitted and connection to the other port numbers may not be permitted. For example, connection to a port number of an even number may be permitted and connection to a port number of an odd number may not be permitted.

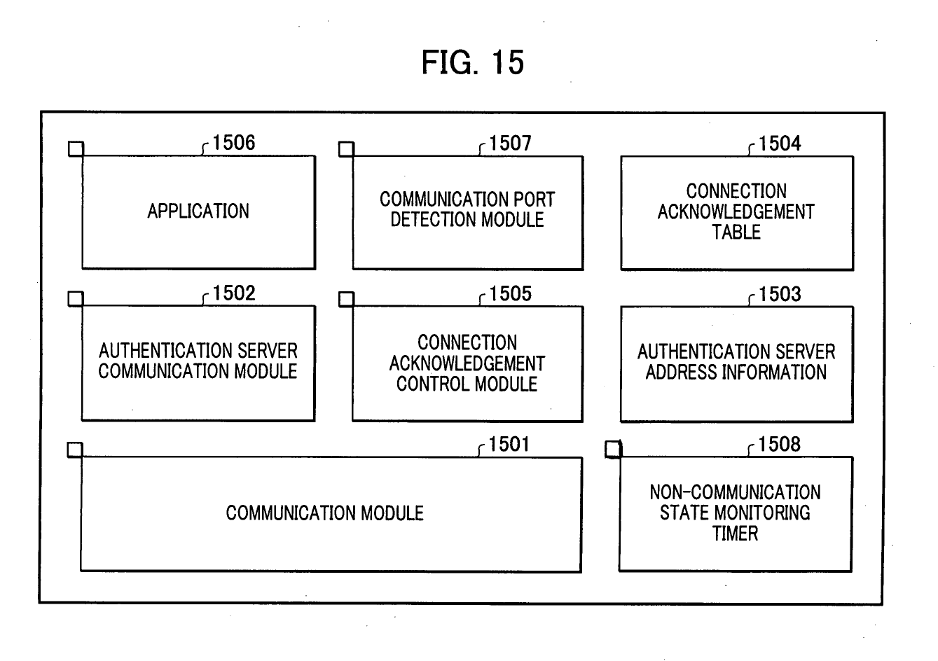

FIG. 15 shows the module structure of software of the terminal B 103 for the modification of the first embodiment described above.

For connection, the connection acknowledgement instruction command in step S1202 is sent from the authentication server 102. The connection acknowledgement instruction command in step S1202 is processed by an authentication server communication module 1502 via a communication module 1501. If the connection acknowledgement instruction command in step S1202 includes a predetermined port number, the authentication server communication module 1502 verifies that the connection acknowledgement instruction command in step S1202 is not a forgery by referring to authentication server address information 1503. If the connection acknowledgement instruction command is sent from the authentication server included in the authentication server address information 1503, the format of the connection acknowledgement instruction command in step S1202 is analyzed to identify the IP address of the terminal A 101 and to set the value in a connection acknowledgement table 1504. Here, all the port numbers are permitted.

Then, when the connection request in step S1206 is sent from the terminal A 101, a connection acknowledgement control module 1505 refers to a connection acknowledgement table 1504 to determine whether to send the connection request to an upper application 1506 or to reject the communication. Here, if the source IP address of the connection request in step S1206 is equal to the source IP address set in the connection acknowledgement table 1504, the terminal A 101 is connected to the upper application 1506 identified by the port number and the protocol class included in the connection request in step S1206.

When communication with the terminal A 101 starts, a communication port detection module 1507 detects the source IP address and the port number used in order to set only one port number in the connection acknowledgement table 1504. In other words, a port number in the receive port number field F513 corresponding to the source IP address in the source IP address field F511 of the connection request command in step S1206 is registered in the connection acknowledgement table 1504. Then, the connection acknowledgement control module 1505 does not permit a connection request for the other port numbers. Although the connection request in step S1206 includes port number information indicating a port number (for example, 80) for connecting to the terminal A 101, after receiving the port number information, the connection acknowledgement control module 1505 does not permit connection for any port number other than the indicated port number (e.g., port 80). The port numbers that are not permitted are identified by the port number information included in the connection request command in step S1206.

The CPU 901 may execute the software (program) shown in FIGS. 14 and 15 and the terminal B 103 according to the modification of the first embodiment may operate as described above. This program may be stored in a predetermined area of the ROM 902 to be read and executed by the CPU 901.

Although the flow of the connection procedure according to the modification of the first embodiment is different from the flow of the connection procedure according to the first embodiment, the structure shown in FIGS. 1 and 3 is also applied to the modification of the first embodiment.

Second Embodiment

A second embodiment of the present invention will now be described.

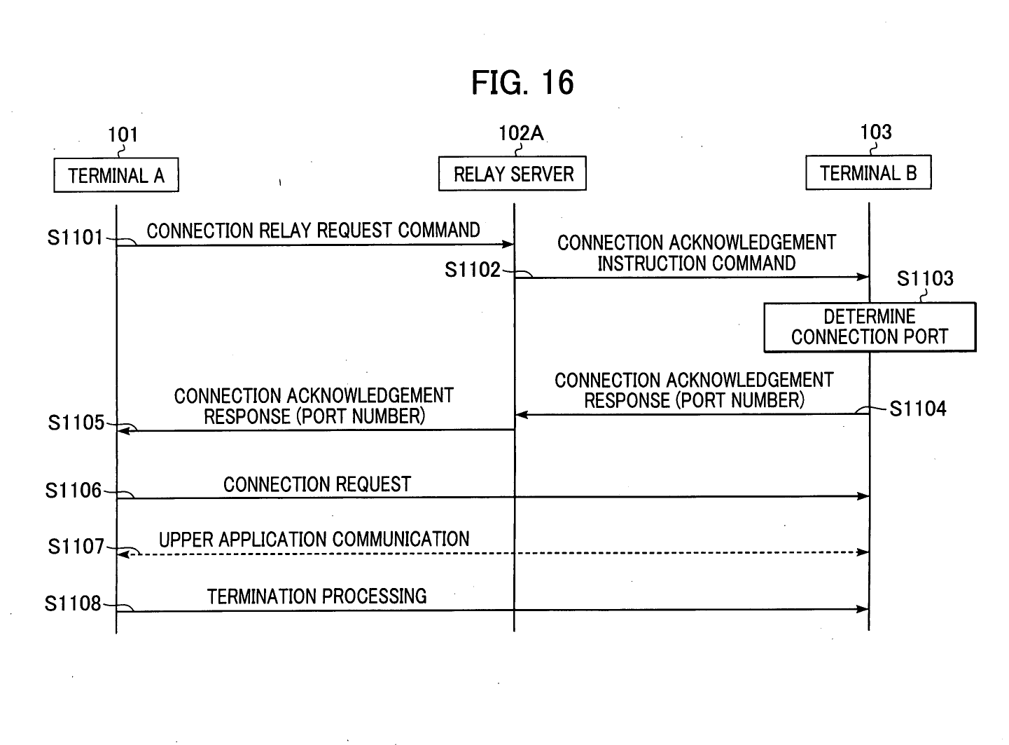

FIG. 16 shows commands and the flow of a connection procedure according to a second embodiment. The structure of the terminal A 101, the terminal B 103, and a relay server 102A corresponding to the authentication server 102 shown in FIG. 1 is the same as the structure of the terminal A 101, the terminal B 103, and the authentication server 102 according to the first embodiment. In the first and second embodiments, for a connection request that designates a predetermined port number, the terminal B 103, which is a receiver, connects an application identified by the port number and the protocol class. In the first embodiment (shown in FIG. 2 and described above), the terminal B 103 permits the connection on the basis of port number information included in the connection acknowledgement instruction command in step S203 and a port number included in the connection request in step S205 sent from the terminal A 101, which is a transmitter. In the second embodiment (shown in FIG. 16), the terminal B 103 determines a port number, and the terminal A 101 sends a connection request including the port number determined by the terminal B 103 in step S1106.

The relay server 102A receives the port number information from the terminal B 103, and sends the port number information received from the terminal B 103 to the terminal A 101, which sends a connection request.

The relay server 102A may determine a port number and may report port number information indicating the determined port number to the terminal A 101 and the terminal B 103, and the terminal A 101 and the terminal B 103 may send a connection request and may determine whether or not to permit the connection, respectively, in accordance with the port number information determined and reported by the relay server 102A. In this case, the report about the port number information sent from the relay server 102A to the terminal B 103 is included, for example, in the connection acknowledgement instruction command sent in step S1102.

The terminal A 101, the terminal B 103, and the relay server 102A perform the operations described below by causing the CPU 901 to execute software stored in the ROM 902 or the HD 907 or software supplied from the FD 908. The CPU 901 performs control to realize the operations of the second embodiment by reading and executing a processing program based on the processing sequence described below from the ROM 902, the HD 907, or the FD 908.

For starting communication with the terminal B 103, the terminal A 101, which sends a connection request, issues a connection relay request command to the relay server 102A in step S1101.

For the format and parameters of the connection relay request command in step S1101, the connection destination port number field F609 and the protocol class field F610 in FIG. 9 are not needed.

When connection is permitted for the connection relay request command in step S1101, the relay server 102A issues a connection acknowledgement instruction command (third signal) to the terminal B 103 in step S1102. The format of the connection acknowledgement instruction command includes the fields F701 to F706 shown in FIG. 10. Here, if the relay server 102A rejects the connection for the connection relay request command in step S1101, a connection negative acknowledgement response NACK is sent to the terminal A 101 as in the first embodiment although this is not shown in FIG. 16 and the explanation about this is omitted here.

In standby mode, the terminal B 103 is set so as to ignore (or reject) any command other than a predetermined command (connection acknowledgement instruction command) sent from the relay server 102A. After receiving the connection acknowledgement instruction command sent from the relay server 102A in step S1102, the terminal B 103 dynamically (for example, in a random fashion) determines a port number permitted for connection in step S1103, and at the same time, permits connection for the port number.

The connection acknowledgement table shown in FIG. 8 is set. The IP address of the terminal A 101 stored in the connection source IP field F706 is extracted from the connection acknowledgement instruction command sent in step S1102 and is set in the source IP address field F511. Also, the port number determined dynamically (for example, in a random fashion) in step S1103 within the terminal B 103 is set in the receive port number field F513. In the second embodiment, the other fields F512 and F514 are not particularly limited. (All the source port numbers in the field F512 is permitted. TCP and UDP protocols in the field F514 are permitted.) A connection port number is determined after receiving the connection acknowledgement instruction command in step S1102 in the second embodiment shown in FIG. 16. However, the port number may be determined before receiving the connection acknowledgement instruction command in step S1102, and the connection source IP address in the connection source IP field F706 included in the connection acknowledgement instruction command in step S1102 and the port number determined in advance may be registered in the fields F511 and F513 in the connection acknowledgement table in accordance with the reception of the connection acknowledgement instruction command in step S1102.

In step S1104, a connection acknowledgement response (first signal) including the connection port number determined in step S1103 is sent to the relay server 102A. This connection port number is port number information identifying the port for accepting a connection based on the connection request sent from the terminal A 101.

In step S1105, the relay server 102A sends the connection acknowledgement response in step S1104, which is received from the terminal B 103, to the terminal A 101. The connection acknowledgement response in step S1105 includes the connection port number determined in step S1103. Although the connection acknowledgement response is sent from the terminal B 103 to the terminal A 101 via the relay server 102A in the second embodiment shown in FIG. 16, the connection acknowledgement response may be sent directly from the terminal B 103 to the terminal A 101, not via the relay server 102A.

After receiving the connection acknowledgement response in step S1105, the terminal A 101 issues a connection request command to the terminal B 103 by using the permitted port number included in the connection acknowledgement response in step in S1106.

Since the IP address of the terminal A 101 and the port number included in the connection request command (second signal) in step S1106 are already set in the connection acknowledgement table shown in FIG. 8 in step S1103, if a connection request including the IP address and the port number is sent (in step S1106), the connection is accepted (permitted). Even if the IP address is included in the connection acknowledgement table 504, connection with a different port number is rejected. Then, in step S1107, upper application communication starts. The upper application is identified by the port number (port number determined in step S1103) and the protocol class included in the connection request in step S1106. In a case where the terminal B 103 uses a predetermined protocol (for example, TCP) or a case where the type of protocol is determined depending on the connection request terminal (for example, a terminal always uses UDP), the protocol class is registered in the RAM 903 or the ROM 902 in advance. In this case, the protocol class is not necessarily included in the connection request in step S1106.

When the upper application communication in step S1107 terminates, a termination processing command is sent in step S1108. After the termination of the communication in step S1107 by the connection request in step S1106, the terminal B 103 deletes (invalidates) the port number determined in step S1103 from the connection acknowledgement table 504. Also, when non-communication elapsed time in the connection acknowledgement table 504 reaches a predetermined value, the port number is made ineffective.

In other words, the terminal B 103 according to the second embodiment sends the connection acknowledgement response (first signal) including the port number information in step S1104, receives the connection request (second signal) in step S1106, and permits connection by the connection request (second signal) in step S1106 on the basis of the port number information.

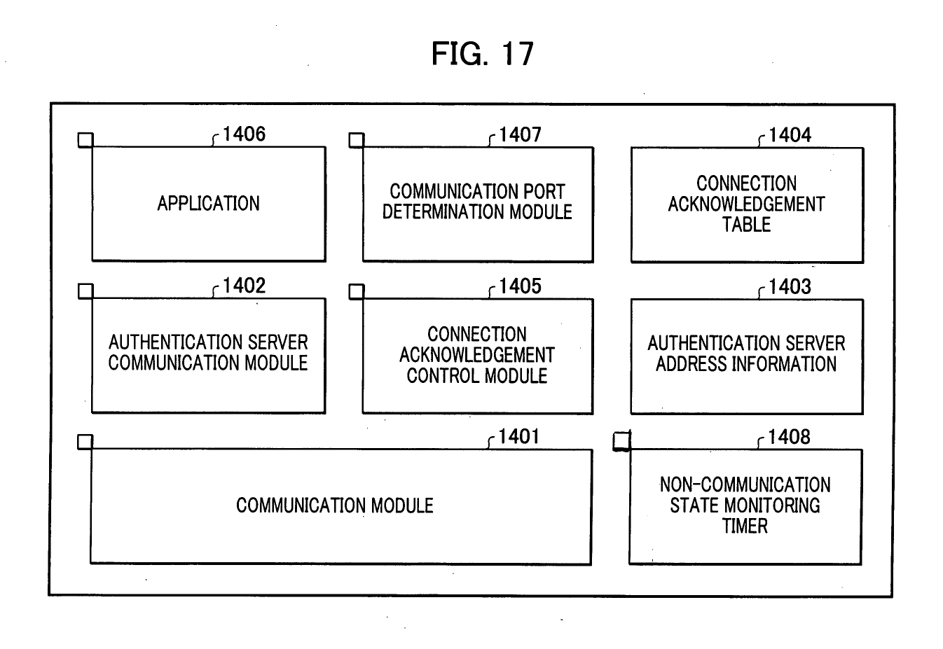

FIG. 17 shows the module structure of software of the terminal B 103.

For connection, the connection acknowledgement instruction command in step S1102 is sent from the relay server 102A. The connection acknowledgement instruction command is processed by an authentication server communication module 1402 via a communication module 1401. Here, it is verified that the connection acknowledgement instruction command in step S1102 is not a forgery by referring to authentication server address information 1403. If the connection acknowledgement instruction command in step S1102 is sent from the relay server 102A included in the authentication server address information 1403, the format of the connection acknowledgement instruction command in step S1102 is analyzed to identify the IP address of the terminal A 101 in the connection source IP field 706. A communication port determination module 1407 determines a connection port number, and the IP address of the terminal A 101 and the determined port number are set in the fields F511 and F513 in a connection acknowledgement table 1404. The port number determined by the communication port determination module 1407 is added in the connection acknowledgement response in step S1104 to be sent to the relay server 102A via the authentication server communication module 1402.

Then, when the connection request in step S1106 is sent from the terminal A 101, a connection acknowledgement control module 1405 refers to the connection acknowledgement table 1404 to determine whether to send the connection request to an upper application 1406 (in other words, to permit connection with the upper application 1406) or to reject the communication (to reject the connection with the upper application 1406).

The CPU 901 may execute the software (program) shown in FIGS. 16 and 17 and the terminal B 103 according to the second embodiment may operate as described above. This program may be stored in a predetermined area of the ROM 902 to be read and executed by the CPU 901.

Although the flow of the connection procedure according to the second embodiment is different from the flow of the connection procedure according to the first embodiment, the structure shown in FIGS. 1 and 3 is also applied to the second embodiment.

Modification of Second Embodiment

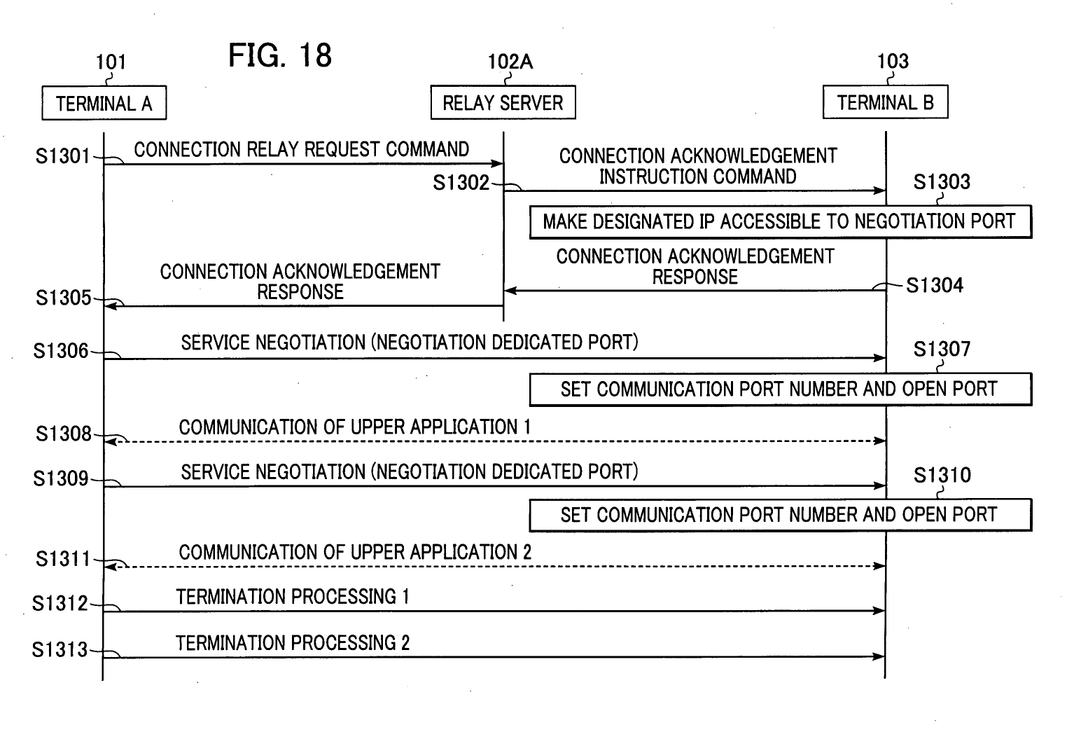

FIG. 18 shows commands and the flow of a connection procedure according to a modification of the second embodiment.

For starting communication with the terminal B 103, the terminal A 101, which sends a connection request, issues a connection relay request command to the relay server 102A in step S1301.

For the format and parameters of the connection relay request command in step S1301, the connection determination port number field F609 and the protocol class field F610 shown in FIG. 9 are not needed.

When connection is permitted for the connection relay request command in step S1301, the relay server 102A issues a connection acknowledgement instruction command to the terminal B 103 in step S1302. The format of the connection acknowledgement instruction command includes the fields F701 to F706 shown in FIG. 10.

In standby mode, the terminal B 103 is set so as to ignore (or reject) any command other than a predetermined command (connection acknowledgement instruction command) sent from the relay server 102A. The terminal B 103 receives the connection acknowledgement instruction command from the relay server 102A, and an access from the designated IP address to a negotiation port number determined in advance is permitted in step S1303.

The connection acknowledgement table in FIG. 8 is set. The connection source IP address in the connection source IP field F706 is extracted from the connection acknowledgement instruction command in step S1302 to be set in the source IP address field F511. Also, a unique and common negotiation port number determined in advance for all the terminals for the system is set in the source port number field F512 and the receive port number field F513. Also, a protocol determined in advance is set in the protocol class field F514.

In step S1304, a connection acknowledgement response is sent to the relay server 102A.

In step S1305, the relay server 102A sends the connection acknowledgement response in step S1304, which is received from the terminal B 103, to the terminal A 101.

The terminal A 101 receives the connection acknowledgement response in step S1305, and performs negotiation with the terminal B 103 for an upper application by using the negotiation port number written in step S1303 and the parameters (values set in the fields F512 to F514) in step S1306. Both the terminal A 101 and the terminal B 103 determine a port number to be used. In an example, a port number desired by the terminal A 101 is sent to the terminal B 103, and the terminal B 103 determines whether or not to permit connection by the port and reports the results. If the terminal B 103 does not permit the connection by the port, the terminal A 101 sends another port number to the terminal B 103 and waits for a reply from the terminal B 103. In another example, a port number desired by the terminal B 103 is sent to the terminal A 101, and the terminal A 101 determines whether or not to permit connection by the port and reports the results to the terminal B 103.

In step S1307, the IP address and the port number determined by step S1306 and used for the upper application are set in the connection acknowledgement table. Specifically, although entries for negotiation with the terminal A 101 are already set in step S1303, another entry is added. The IP address of the terminal A that performs negotiation is set in the source IP address field F511 and parameters determined by the negotiation in step S1306 are set in the fields F512, F513, and F514.

Then, communication of an upper application 1 starts in step S1308.

If an upper application 2 is desired to be used, negotiation between the terminal A 101 and the terminal B 103 for the upper application 2 is performed by using a negotiation port to determine a new port number in step S1309, as in step S1306, and then, new entries for the upper application 2 are added in the connection acknowledgement table 504 in step S1310, as in step S1307.

Then, communication of the upper application 2 starts in step S1311.

After termination of the communication of the upper application 1 in step S1308, a termination processing command 1 is sent in step S1312.

After termination of the communication of the upper application 2 in step S1311, a termination processing command 2 is sent in step S1313. The order of terminating the communications need not be in the order shown. The termination of upper application 2 (step S1313) could precede the termination of upper application 1 (step S1312).

As with the embodiments described above, the communication termination processing (in steps S1312 and S1313) may be performed by the terminal A 101 or by a non-communication state monitoring timer 1408.

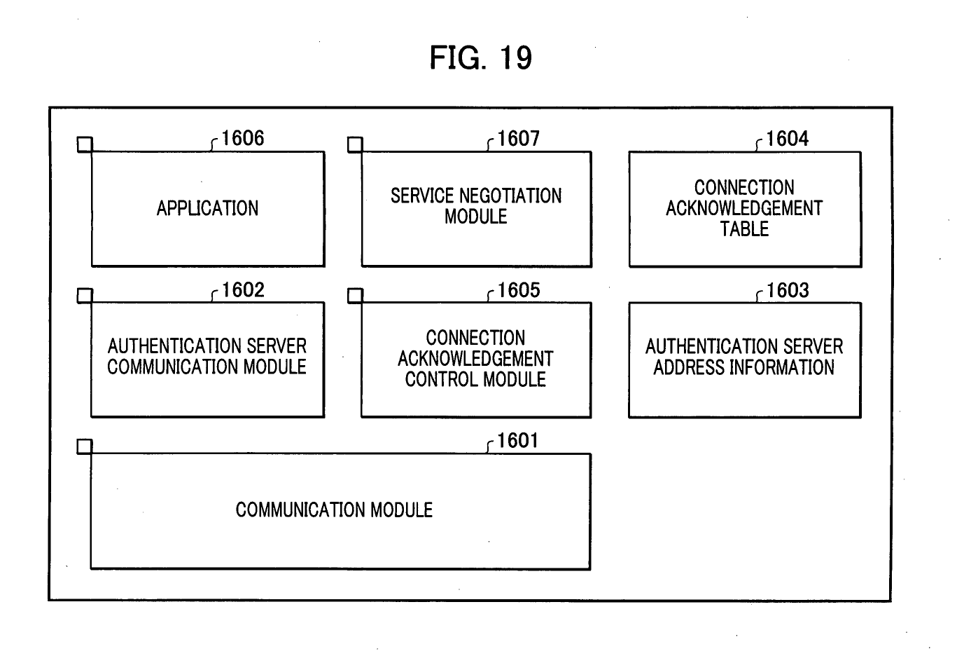

FIG. 19 shows the module structure of software of the terminal B 103 for the modification of the second embodiment described above.

For connection, the connection acknowledgement instruction command in step S1302 is sent from the relay server 102A. The connection acknowledgement instruction command in step S1302 is processed by an authentication server communication module 1602 via a communication module 1601. Here, it is verified that the connection acknowledgement instruction command is not a forgery by referring to authentication server address information 1603. If the connection acknowledgement instruction command is sent from the relay server included in the authentication server address information 1603, the format of the connection acknowledgement instruction command in step S1302 is analyzed to identify the IP address of the terminal A 101 and to set the value in a connection acknowledgement table 1604. Here, a port number is a negotiation port number determined in advance among terminals used for the system.

Then, when the connection negotiation request is sent from the terminal A 101 in step S1306, a connection acknowledgement control module 1605 refers to the connection acknowledgement table 1604 to determine whether to send the connection request to a service negotiation module 1607 or to reject the connection.

The service negotiation module 1607 performs negotiation with the terminal A 101 for communication including a port number to be used.

The IP address of the terminal A 101 and the port number determined by this communication are set in the connection acknowledgement table 1604.

Then, when a connection request for application communication is sent from the terminal A 101, the connection acknowledgement control module 1605 refers to the connection acknowledgement table 1604 to determine whether to send the connection request to an upper application 1606 or to reject the communication.

Also, even in the process of communication, a new port number can be used via the service negotiation module 1607 for communication of a new application.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A receiver comprising:
receiving means for receiving first and second signals; and
permitting means for permitting connection with a connection request source based on a port number included in the second signal when the first signal satisfies a predetermined condition.

2. A receiver according to claim 1, wherein the permitting means permits the connection with the connection request source based on the port number included in the second signal when the first signal includes data indicating a predetermined source.

3. A receiver according to claim 1, wherein the permitting means permits the connection with the connection request source based on the port number and data indicating a source included in the second signal in accordance with reception of the first signal including data that indicates first and second sources.

4. A receiver according to claim 1, wherein the permitting means restricts a port for permitting the connection with the connection request source based on the port number included in the second signal when the first signal satisfies the predetermined condition.

5. A receiver according to claim 1, wherein the permitting means includes transmitting means for sending port information corresponding to a port for accepting the connection with the connection request source in accordance with reception of the first signal satisfying the predetermined condition and permits the connection with the connection request source based on the port number included in the second signal.

6. A receiver according to claim 1, wherein the permitting means communicates with the connection request source for determining a port to be used in accordance with reception of the first signal satisfying the predetermined condition and permits the connection with the connection request source based on the port number included in the second signal.

7. A receiver comprising:
receiving means;
transmitting means for sending a sending signal including port information corresponding to a port for accepting a connection request, the port being variable; and
permitting means for permitting the connection request by a receiving signal that designates the port corresponding to the port information.

8. A receiver according to claim 7, wherein the transmitting means sends the sending signal including the port information in accordance with reception of a predetermined signal.

9. A receiver comprising:
receiving means for receiving first and second signals, the second signal including data designating a program; and
permitting means for permitting connection with a connection request source based on the data designating the program when the first signal satisfies a predetermined condition.

10. A receiver according to claim 9, wherein the permitting means permits the connection with the connection request source based on the data designating the program when the first signal includes data indicating a predetermined source.

11. A receiver according to claim 9, wherein the permitting means permits the connection with the connection request source based on the data designating the program and data indicating a source in accordance with reception of the first signal including data that indicates first and second sources.

12. A receiver comprising:
transmitting means for sending a sending signal including first data;
receiving means for receiving a receiving signal including second data that designates a program; and
permitting means for permitting a connection request by the receiving signal when the second data corresponds to the first data.

13. A connection controller comprising:
receiving means for receiving a first signal from a first device; and
transmitting means for sending a second signal to a second device, the second signal designating a port of the first device for accepting a connection request from the second device.

14. A connection controller according to claim 13, wherein the transmitting means sends the second signal to the second device when connection with the first device by the second device is permitted.

15. A transmitter comprising:
receiving means for receiving a first signal from a connection controller; and
transmitting means for sending a second signal including a port number designated by the first signal to a connection request destination.

16. A transmitter according to claim 15, wherein the transmitting means sends a connection request to the connection controller and the receiving means receives the first signal corresponding to the connection request.

17. A receiving method comprising:
sending a sending signal including port information corresponding to a port for accepting a connection request, the port being variable; and
permitting the connection request by a receiving signal that designates the port corresponding to the port information.

18. A receiving method according to claim 17, wherein the sending signal including the port information is sent in accordance with reception of a predetermined signal.

19. A receiving method comprising:
receiving first and second signals, the second signal including data designating a program; and
permitting connection with a connection request source based on the data designating the program when the first signal satisfies a predetermined condition.

20. A receiving method according to claim 19, wherein the connection with the connection request source is permitted based on the data designating the program when the first signal includes data indicating a predetermined source.

21. A receiving method according to claim 19, wherein the connection with the connection request source is permitted based on the data designating the program and data indicating a source in accordance with reception of the first signal including data that indicates first and second sources.

22. A receiving program comprising instructions for performing a receiving method comprising:
sending a sending signal including port information corresponding to a port for accepting a connection request, the port being variable; and
permitting the connection request by a receiving signal that designates the port corresponding to the port information.

23. A receiving program according to claim 22, wherein the sending signal including the port information is sent in accordance with reception of a predetermined signal.

24. A receiving program comprising instructions for performing a receiving method comprising:
receiving first and second signals, the second signal including data that designates a program; and
permitting connection with a connection request source based on the data designating the program when the first signal satisfies a predetermined condition.

25. A receiving program according to claim 24, wherein the connection with the connection request source is permitted based on the data designating the program when the first signal includes data that indicates a predetermined source.

26. A receiving program according to claim 24, wherein the connection with the connection request source is permitted based on the data designating the program and data indicating a source in accordance with reception of the first signal including data that indicates first and second sources.

27. A connection control method comprising:
receiving a first signal from a first device; and
sending a second signal to a second device, the second signal designating a port of the first device for accepting a connection request from the second device.

28. A connection control method according to claim 27, wherein when connection with the first device by the second device is permitted, the second signal is sent to the second device.

29. A sending method comprising:
receiving a first signal from a connection controller; and
sending a second signal including a port number designated by the first signal to a connection request destination.

30. A sending method according to claim 29, wherein the second signal comprises a connection request, and the first signal corresponds to the connection request.

31. A sending program comprising instructions for performing a sending method comprising:
receiving a first signal from a connection controller; and
sending a second signal including a port number designated by the first signal to a connection request destination.

32. A sending program according to claim 31, wherein the second signal comprises a connection request, and the first signal corresponds to the connection request.
